(19) United States
(12) Patent Application Publication
(10) Pub. No.: US 2026/0338584 A1
(43) Pub. Date: Oct. 29, 2026

(54) TELEMETRY DATA AGGREGATION AND DISTRIBUTION

(71) Applicant: CoreWeave, Inc., Livingston, NJ (US)

(72) Inventors: Ronald Munroe Howell, Ontario (CA); Theodore Cincotta, San Francisco, CA (US); Edward Isaac Gutman Sparling, Estes Park, CO (US); Nicholas Andre Chiumento, Austin, TX (US); Peter Thomas Salanki, New York, NY (US); Amanda Paige Edades, Seattle, WA (US); Mark Stansberry, Roseland, NJ (US); Dana Renfrow, Roseland, NJ (US); Yitzchok Dier, Fair Lawn, NJ (US)

(21) Appl. No.: 19/647,368

(22) Filed: Apr. 14, 2026

Related U.S. Application Data
(60) Provisional application No. 63/788,555, filed on Apr. 14, 2025.

(51) Int. Cl. G01D 9/00

(52) U.S. Cl. CPC G01D 9/00

(57) ABSTRACT

Systems and methods for implementing integrated telemetry services deployments in a centralized telemetry pipeline. The method includes maintaining, in a data center comprising a plurality of computing nodes, a plurality of integrated telemetry services deployments; receiving, by a telemetry manager subsystem for a user of the data center, configuration information specifying one or more types of telemetry data for a computing cluster of the data center provisioned for the user; providing, by the telemetry manager subsystem to one or more integrated telemetry services deployments, the user-specified configuration information; and processing, by the one or more integrated telemetry services deployments, telemetry data according to the user-specified configuration information.

### CROSS REFERENCE TO RELATED APPLICATIONS

This application claims priority to U.S. Provisional Application No. 63/788,555 filed on Apr. 14, 2025. The disclosure of the prior application is considered part of and is incorporated by reference in the disclosure of this application.

### BACKGROUND

This specification relates to high-performance data centers.

A high-performance data center is a facility that houses many co-located computing nodes in order to efficiently execute computing workloads that benefit from substantial parallel processing power. Such workloads are common in the fields of artificial intelligence and machine learning, scientific simulations, data analysis, and image rendering.

A computing cluster in a data center refers to a group of multiple networked computing nodes that have been configured, e.g., by a user of the data center, to operate on delegated portions of a task. Operating many computing nodes concurrently in a cluster can efficiently scale the performance throughput for many high-performance computing tasks. Each computing node typically has at least one central processing unit (CPU) to effectuate an operating system and network communications and can also have additional acceleration hardware to scale up the parallel processing performance of the cluster.

A single data center typically provisions multiple different computing clusters for multiple respective users. Typically the users are customers of an operator entity that provides the high-performance computing capabilities of the data center as a service. For example, users can be individual users, corporations, universities, or other types of organizations, to name just a few examples.

Users of a data center typically do not have visibility into the inner workings of a data center. Rather, the user is provided identifying information regarding the computing nodes provisioned for the user's cluster as well as interfaces for providing input and receiving output of the computing task as it executes.

Users can also choose to provision resources in their cluster for cluster telemetry, which is data that represents the state of the cluster. Typically telemetry data includes log messages and performance metrics. For example, in some systems, a user can provision in their cluster a publish and subscribe service that can obtain log messages generated by the computing components in a cluster and can forward these log messages to other locations, e.g., an endpoint for generating a user interface presentation that illustrates the state of computing resources in a cluster.

However, these prior approaches to telemetry suffer from several drawbacks. First, users running publish and subscribe services in their clusters usually require some expertise in how such systems are designed and how they operate. Therefore, deploying telemetry services in a cluster is often a time-consuming task that either requires expert users to set up and configure or that requires employees of the data center operator to perform customer service tasks in order to configure the telemetry services, which violates the desired self-service tenets of cloud computing platforms.

In addition, running publish and subscribe services usually consumes additional computing resources in the user's cluster. This can either degrade performance or make the cluster more expensive to operate. And when many users are provisioning such services in their clusters, this reduces the overall capacity for high performance computing tasks that the data center is able to accommodate. In addition, the telemetry data is typically confined to the internal network of the user's cluster. Therefore, there is not an easy way to access such telemetry data by systems external to the data center.

### SUMMARY

This specification describes how a data center can efficiently use integrated telemetry services deployments in a centralized telemetry pipeline. This arrangement provides durable mechanisms for fanning in telemetry data to the centralized telemetry subsystem, where the telemetry data can then be fanned back out to external endpoints. In this specification, a telemetry services deployment refers to a group of coordinating computing resources in a data center that have been configured to collect telemetry data generated by one or more resources in the data center. In this specification, an integrated telemetry services deployment means that the deployment is executing as part of the underlying data center platform as opposed to being launched by users on computing nodes belonging to users of the data center.

Particular embodiments of the subject matter described in this specification can be implemented so as to realize one or more of the following advantages.

Traditionally, to obtain telemetry data, users needed to provision and launch resources in their own computing clusters. However, the techniques described in this specification implement an integrated centralized telemetry pipeline, including one or more telemetry services deployments, to deliver telemetry data to users. That is, the integrated centralized telemetry pipeline is already continuously running to collect and provide telemetry data for management and maintenance of the data center, and can be reconfigured to also deliver telemetry data to a user for their own computing cluster(s). The techniques described herein enable users to set up telemetry services by providing only a relatively small amount of configuration data (e.g., type of telemetry data, the endpoints to which the telemetry data should be delivered) through a user interface of a telemetry manager subsystem. As an example, a user can reconfigure the integrated telemetry services deployments to provide the telemetry data to the user for their own computing cluster(s) within the data center. Therefore, the techniques described herein can more efficiently manage resources by allowing users to simply reconfigure the endpoints to which the telemetry data is being delivered to accommodate user requests for telemetry data.

Additionally, the techniques described herein can optimize the efficiency of the data center and the allocation of the data center resources by provisioning integrated telemetry services deployments so that multiple different users are serviced by a single telemetry deployment. Thus, the number of required telemetry deployments is not required to scale at the same rate as the number of users scales up. This in turn means that the data center has more overall capacity for other computing tasks.

The telemetry manager subsystem can automatically reconfigure one or more integrated telemetry services deployments so that users can begin receiving the requested telemetry data, all without requiring the users to provision or launch any additional services, such as telemetry collection services. This is because the integrated telemetry services deployments were already up and running before the user provided the configuration data. Therefore, users can start receiving telemetry data in minutes rather than in hours or days, significantly reducing complexity and set-up time for configuring telemetry services. Additionally, the telemetry services can be provided to the user out of the box, such that the user can proceed towards their primary usage goal of the cluster, e.g., high performance computing, without having to set up their own ancillary services to ensure that the primary workload is running successfully. Furthermore, the users need not be experts in telemetry systems in order to start receiving sophisticated telemetry information.

In addition, the techniques described in this specification allow for seamless multi-data center telemetry services. In other words, each data center facility can run an appropriate number of telemetry services deployments, which can all stream their telemetry data to a centralized telemetry subsystem. This provides further deployment advantages for users, who need not set up and deploy publish and subscribe services in every data center in which they have computing clusters. Rather, a user can provide, through a user interface, configuration data that simply requests the user's telemetry data from all data centers or a subset thereof, and the already-running integrated telemetry services deployments simply get reconfigured to begin streaming the requested telemetry data.

Another benefit is that data center operators and data center users can be serviced by the same integrated telemetry system. Typically data center operators have access to different types and sources of telemetry data than users do. Therefore, in addition to user deployments of publish and subscribe services, data centers often separately run telemetry services for the operators of the data center itself. But using the techniques described in this specification, the integrated telemetry services deployments can serve data center operators and users of the data center alike, which further increases the overall operational efficiency of the data center. The centralized telemetry subsystem can employ filtering and access controls in order to route data to appropriate endpoints.

Additionally, the centralized telemetry pipeline provides for virtually boundless flexibility on the types of user endpoints to which telemetry data should be delivered. Configuring these endpoints can be as simple as selecting an option in a dropdown menu and providing a location for the requested telemetry data.

In addition, the centralized telemetry subsystem allows for powerful routing and filtering capabilities that allow users to filter on data types and route filtered data to different endpoints. For example, a user can specify that security data gets routed to a security analysis subsystem and can specify that training job data gets routed to an application performance analysis subsystems, all without the user having to launch or manually configure any data processing pipelines. To that end, each user will be able to define different endpoints where different subsets of their telemetry will be forwarded.

Moreover, the techniques described in this specification are designed such that different delivery guarantees can be made for different subsets of data. For example, users may require lower latency or lower data loss for certain subsets of data, and the techniques described in this specification can be efficiently tuned to meet different needs for different subsets of data. As a result, overall efficiency of the system is improved by not wasting resources to ensure strong guarantees on telemetry data for which those guarantees are not required.

The centralized telemetry pipeline also allows the data center operator to provide easy compatibility with connector subsystems that forward data to external systems. For example, a user can select a particular connector subsystem type, and the data center can designate the selected connector subsystem type as the endpoint for the user's telemetry data. This functionality also allows using connector subsystems to provide a private gateway into a user's private internal systems. For example, the system can use a particular connector that supports forwarding data to a virtual private cloud that is not otherwise addressable from inside the data center.

Additionally, the centralized telemetry pipeline can leverage different levels of telemetry data granularity. That is, the centralized telemetry pipeline can provide data coverage across the whole stack down to the bare metal layer, e.g., node/kernel logs, network fabric logs and platform metrics (Redfish, NVSwitch, DCGM, BMC etc).

In general, in a first aspect, a computer-implemented method includes maintaining, in a data center including one or more computing nodes, one or more integrated telemetry services deployments, receiving, by a telemetry manager subsystem for a user of the data center, configuration information specifying one or more types of telemetry data for a computing cluster of the data center provisioned for the user, providing, by the telemetry manager subsystem to one or more integrated telemetry services deployments, the user-specified configuration information, and processing, by the one or more integrated telemetry services deployments, telemetry data according to the user-specified configuration information.

In a second aspect combinable with the first aspect, the one or more integrated telemetry services deployments are executing before the configuration information is provided.

In a third aspect combinable with the first or second aspects, each integrated telemetry services deployment is configured to service telemetry data from one or more different users.

In a fourth aspect combinable with the third aspect, the one or more different users served by a particular telemetry services deployment are unaffiliated with one another.

In a fifth aspect combinable with any of the first through fourth aspects, the one or more integrated telemetry services deployments service both users and operators of the data center.

In a sixth aspect combinable with any of the first through fifth aspects, the method further includes providing, by the one or more integrated telemetry services deployments, the processed telemetry data to a centralized telemetry subsystem.

In a seventh aspect combinable with the sixth aspect, the method further includes providing, by the centralized telemetry subsystem, the processed telemetry data to one or more user endpoints.

In an eighth aspect combinable with any of the first through seventh aspects, a second data center maintains its own integrated telemetry services deployments, and the method further includes processing, by the one or more integrated telemetry services deployments of the second data center, telemetry data generated by computing clusters in the second data center, and providing, by the one or more integrated telemetry services deployments of the second data center, the processed telemetry data to the centralized telemetry subsystem.

In a ninth aspect combinable with the eighth aspect, the centralized telemetry subsystem executes in a data center different than the second data center.

In a tenth aspect combinable with any of the first through ninth aspects, the method further includes maintaining, by the data center, one or more connector subsystems that are configured to route data from the centralized telemetry subsystem to one or more external subsystems.

In an eleventh aspect combinable with the tenth aspect, a first connector subsystem is configured to route data to a virtual private cloud that is not addressable from inside the data center.

In a twelfth aspect combinable with any of the first through eleventh aspect, the configuration information specifies a quality of service parameter value for a particular type of telemetry data, and where the centralized telemetry subsystem operates to effectuate the requested quality of service parameter value for the particular type of telemetry data.

In a thirteenth aspect combinable with any of the first through twelfth aspects, the configuration information specifies how to filter telemetry data by type.

In a fourteenth aspect combinable with any of the first through twelfth aspects, the configuration information specifies routing different types of telemetry data to different endpoints.

In a fifteenth aspect combinable with any of the first through twelfth aspects, the configuration information is received through a user interface.

In a sixteenth aspect combinable with any of the first through twelfth aspects, the configuration information is received from an additional computing component.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The details of one or more embodiments of the subject matter will become apparent from the description, drawings, and the claims.

Other features, aspects, and advantages of the subject matter will become apparent from the description, drawings, and the claims.

### BRIEF DESCRIPTION OF THE DRAWINGS

FIG. 1 illustrates an example system that includes a computing cluster and a telemetry deployment.

FIG. 2 illustrates an example system that includes one or more computing clusters and a telemetry deployment.

FIG. 3 shows an example of a telemetry deployment.

FIG. 4 illustrates the relationship between the leaf and spine clusters of a telemetry deployment.

FIG. 5 is a flow diagram for an example process for processing user-specified telemetry data.

Like reference numbers and designations in the various drawings indicate like elements.

### DETAILED DESCRIPTION

This specification describes how a data center can implement integrated telemetry services deployments in a centralized telemetry pipeline. The implementation of integrated telemetry services deployments can enable users to receive telemetry data without needing to provision and launch their own resources. More specifically, the integrated telemetry services deployments can continuously collect telemetry data for provisioning to an operator of the data center for maintenance and management, and can be reconfigured, upon request by a user, to provision particular telemetry data to particular user endpoints defined by the user. In such a manner, the techniques described in this specification can leverage a centralized telemetry pipeline built into the data center to collect and process telemetry data for (i) provisioning telemetry data to an operator of the data center for management and maintenance of the computing clusters of the data center and upon request, (ii) provisioning telemetry data for a user based on configuration information that details the type of telemetry data desired and the user endpoints to which the telemetry data should be provided.

In this specification, a computing node is a physical device that includes multiple co-located subsystems. Being co-located means that these subsystems are in close physical proximity, e.g., being co-located within a same rack or the compute tray, and are controlled by a same central processing subsystem that includes one or more physical central processing units (CPUs). A computing node can also include a parallel processing subsystem having one or more hardware accelerator units, which can be any appropriate device having processing elements that are able to be executed in parallel, for example, a GPU, a TPU, an NPU, an FPGA, or an ASIC that provides such functionality. A computing node can also include a local storage subsystem (e.g., a local disk cache, or a cluster-wide cache) having one or more data storage devices, for example, one or more solid state disk drives.

A computing cluster configured to execute a particular computing task includes multiple computing nodes. In some implementations, the computing clusters can be specialized Kubernetes clusters. In some cases, the computing cluster can be communicatively coupled to one or more integrated telemetry services deployments that can obtain and process telemetry data from the multiple computing nodes. As described above, the integrated telemetry services deployment can correspond to a computing subsystem that is configured to collect telemetry data generated by one or more resources in the data center, such as, for example, each computing node of a computing cluster. The integrated telemetry services deployment can be automatically configured to collect telemetry data generated by the one or more resources in the data center, for example, each of the computing nodes of the computing clusters. That is, the integrated telemetry services deployments can continuously collect telemetry data for various purposes, even if the one or more users of the data center have not requested telemetry data. For example, the telemetry data can be utilized by the operators of the data center for evaluation, management, and maintenance of the computing nodes. These integrated telemetry services deployments can be leveraged for telemetry data provisioning to one or more users of the data center, such that each user of the data center can receive user-specified telemetry data from their particular computing clusters at a user-specified endpoint.

The techniques described in this specification illustrate how a data center can efficiently implement an integrated telemetry services deployment in a centralized telemetry pipeline. The centralized telemetry pipeline can be leveraged to provide telemetry data to (i) an operator of the data center for evaluation and maintenance, and (ii) users of the data center. The user can input configuration data descriptive of the type of telemetry data desired and the endpoint to which the telemetry data should be delivered, and the techniques described in this specification can reconfigure the integrated telemetry services deployment to deliver the particular telemetry data to the user at the given endpoint(s).

Each integrated telemetry services deployment can be implemented by software executed by the central processing subsystem of the computing node on which it is executing. In some implementations, each integrated telemetry services deployment is implemented by a container executed by a container runtime environment.

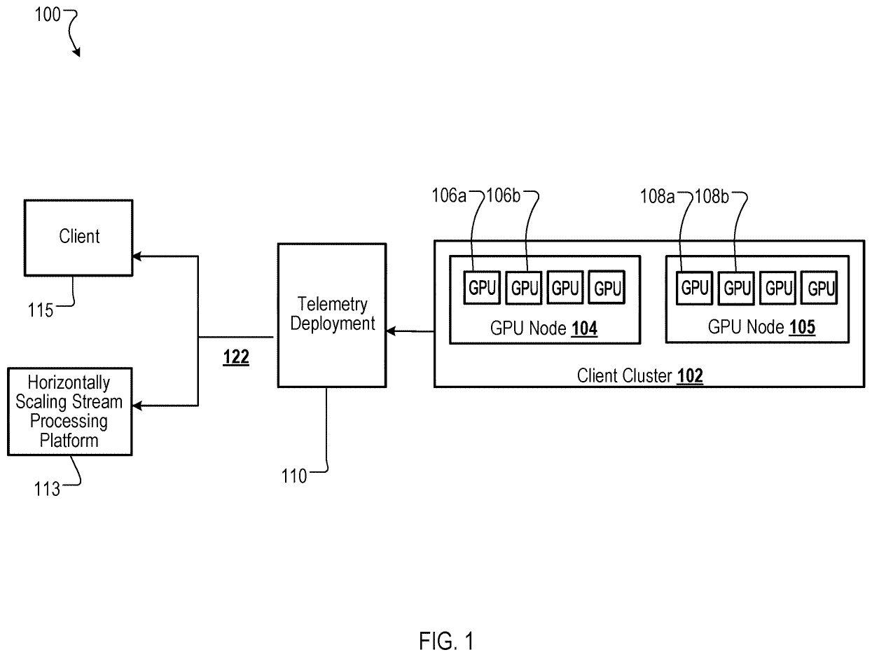

FIG. 1 illustrates an example system that includes a computing cluster 102. The example computing cluster 102 includes two computing nodes (the computing node 104 and a computing node 105).

The computing node 104 includes one or more hardware accelerator units (e.g., GPUs) to execute computing workloads. For example, computing node 104 can include GPU 106a and GPU 106b. The computing node 104 can be communicatively coupled to an integrated telemetry services deployment 110 that receives telemetry data from the GPU 106a and 106b, which can be based on the performance of the computing workloads.

The example system 100 depicts hardware accelerators as GPUs but other computing devices, including CPUs, can be assigned to perform computational tasks and configured to provide telemetry data to the integrated telemetry services deployment 110. The telemetry data provided to the integrated telemetry services deployment 110 can be any appropriate type of telemetry data. For example, the telemetry data can be any telemetry data descriptive of the health and status of the computing components of the data center. For example, the telemetry data can be GPU data, including (i) how much data goes into a GPU, (ii) how much data is coming out of the GPU, (iii) one or more networks connecting the GPU with one or more computing components, (iv) health of network ports, etc. In some implementations, the telemetry data can be grouped into specific (i) logs, and (ii) metrics. For example, the logs can include audit logs, pod logs, network logs, console logs, API logs, fabric logs, etc. In some implementations, one or more of the logs can be Kubernetes logs. For example, the metrics can include disk I/O metrics, network metrics, fabric metrics, rack-level data metrics, billing related metrics, etc. As a specific example, the networking logs can correspond to timestamped text records of discrete network events (e.g., connection refused, firewall blocked, etc.), and networking metrics can correspond to numerical measurements taken at specific time intervals that detail the quantity and performance of network traffic. In some implementations, the telemetry data can further include (iii) events, such as auditable events.

The integrated telemetry services deployment 110 can be configured to service one or more computing nodes in one or more computing clusters. For example, as depicted in FIG. 1, the integrated telemetry services deployment 110 is configured to collect and process telemetry data from computing node 104, (e.g., the GPUs 106a-b or any other computing components of the node 104) and the computing node 105 (e.g., GPUs 108a-b or any other computing components of the node 105) for data provisioning to a horizontally scaling stream processing platform 113 of the data center and in some cases, a customer 115. In typical systems, the computing node 104 can include telemetry deployments provisioned by the user. The present specification describes a method for the computing node 104 to leverage an integrated telemetry service deployment 110 (e.g., provisioned by the data center directly) by reconfiguring the continuously running integrated telemetry services deployment 110 executed on one or more computing nodes to provide the user with telemetry data without requiring the user to provision or launch anything within their own cluster. That is, the integrated telemetry services deployment 110 is already continuously running to collect and provide telemetry data for management and maintenance of the data center, and can be reconfigured to also deliver telemetry data to a user.

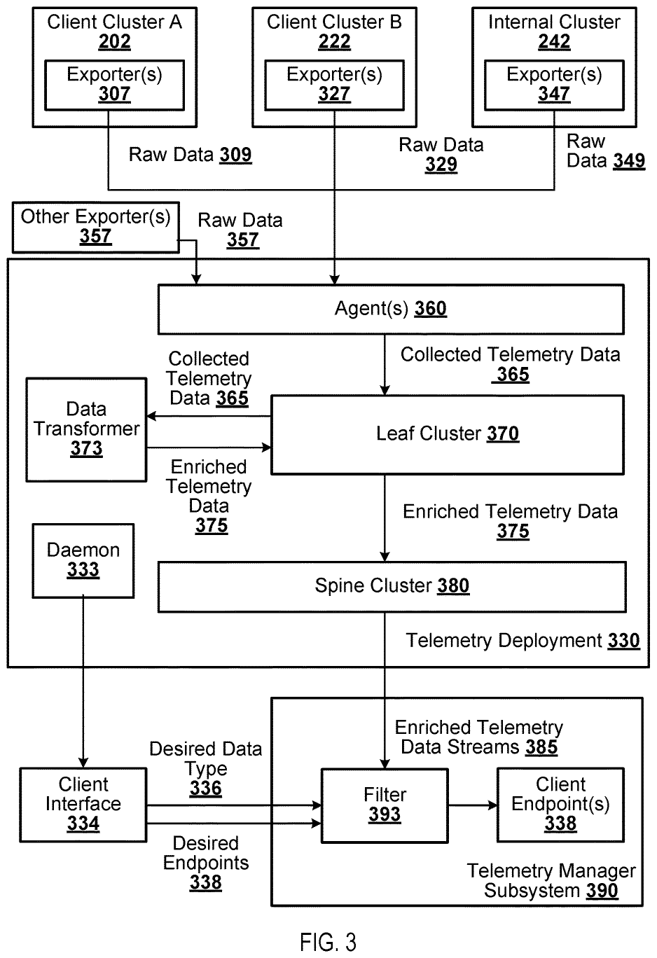

The integrated telemetry services deployment 110 is communicatively coupled to an horizontally scaling stream processing platform 113 configured to receive and persist significant amounts of data, and a client 115 via data path 122. The integrated telemetry services deployment 110 can transmit telemetry data to the horizontally scaling stream processing platform 113 of the data center and/or the client 115. The integrated telemetry services deployment 110 can transmit the processed telemetry data in its entirety to the horizontally scaling stream processing platform 113. In some implementations, the horizontally scaling stream processing platform 113 can be a component in a centralized telemetry subsystem. The integrated telemetry services deployment 110 can transmit the telemetry data to the client 115 based on configuration information specifying one or more types of telemetry data for a computing cluster of the data center provisioned for the user. In some implementations, the configuration information can be provided by the user in response to a request of the user for telemetry data. The user can request the telemetry data in a variety of manners. For example, the user can query the integrated telemetry services deployment 110 for particular telemetry data in the moment and/or the user can configure the integrated telemetry services deployment 110 to forward, at one or more future intervals, particular telemetry data to a client endpoint outside of the data center using a user interface (e.g., the user interface 334 of FIG. 3). In some implementations, the configuration information can be provided by a computing component of the system 100, such as, for example, one or more artificial intelligence (AI) models and/or one or more master control planes (MCPs) for the computing cluster of the data center provisioned for the user. In some implementations, the MCP can be a cluster-management MCP that can determine and provide the configuration information to the integrated telemetry services deployment 110. The configuration information can be any appropriate information characterizing the request of the user for telemetry data. For example, the configuration information can specify (i) how to filter telemetry data by type and/or (ii) routing different types of telemetry data to different endpoints. As another example, the configuration information can further specify a quality of service parameter value for a particular type of telemetry data. For example, the quality of service parameter can be a completeness parameter that measures the number of time intervals (e.g. 30 seconds, 1 minute, 2 minute, 5 minutes, 1 hour, etc.) within a month where a particular percentage of logs are successfully forwarded to a user-defined endpoint. As another example, the quality of service parameter can be a latency parameter that measure the number of logs where there is greater than a period of time (e.g., 30 seconds, 1 minute, 2 minutes, 5 minutes, 1 hour, etc.) between when they are first emitted and the time when they are forwarded. That is, the integrated telemetry services deployment can transmit the processed telemetry data (or a subset of the processed telemetry data) to one or more user endpoints.

The computing node 105 also includes hardware accelerator units (e.g., GPU 108a and GPU 108b) for performing computing workloads and can be communicatively coupled to the integrated telemetry services deployment 110 to transmit telemetry data to the integrated telemetry services deployment 110.

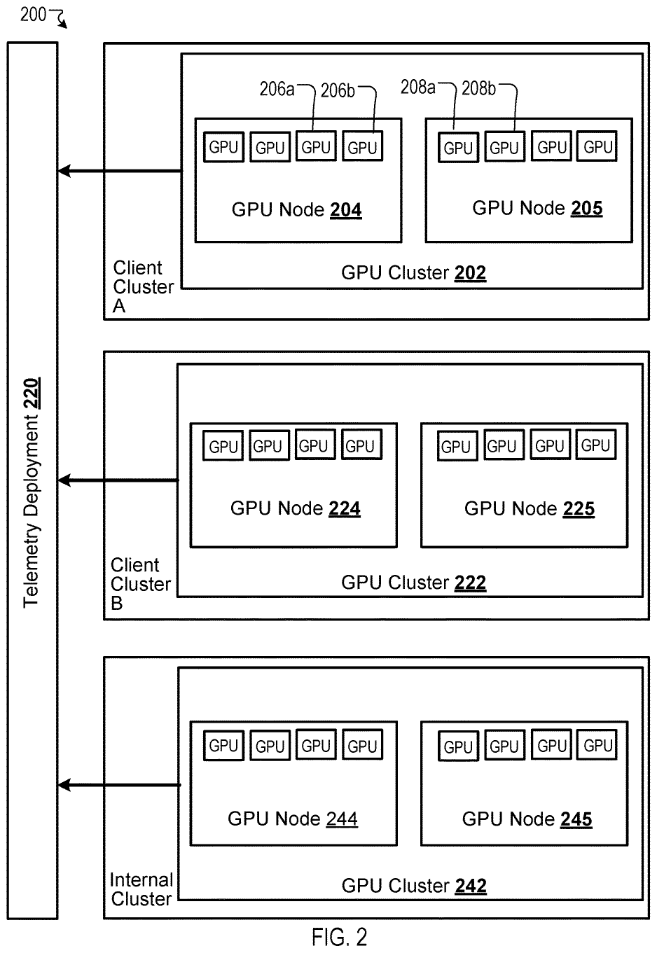

FIG. 2 illustrates an example system 200 that includes one or more computing clusters and an integrated telemetry services deployment 210.

As depicted in FIG. 2, the integrated telemetry services deployment 210 can service one or more computing clusters, such as client cluster A 202, client cluster B 222, and internal cluster 242. The integrated telemetry services deployment 210 can service any number of appropriate computing clusters based on one or more attributes, such as, for example, power consumption of the computing cluster (e.g., how much power is dedicated to the GPUs of the computing cluster) or workload volume (e.g., how much data is produced). For example, an integrated telemetry services deployment 210 can service 3 computing clusters, 5 computing clusters, 10 computing clusters, etc. In such an example, as the data center provisions new customer clusters, in some cases, the integrated telemetry services deployment 210 can service the new customer clusters, without having to provision a second integrated telemetry services deployment. In another example, if the data center provisions 10 new customer clusters, in some cases, only a second integrated telemetry services deployment needs to be provisioned, instead of multiple (e.g., 2, 5 or even 10 new telemetry deployments).

As described above, a client cluster, such as client cluster A 202 and client cluster B 222, can be a computing cluster corresponding to a group of multiple networked computing nodes that have been configured, e.g., by a user of the data center, to operate on delegated portions of a task. In some implementations, the client cluster A 202 and the client cluster B 222 can be computing clusters for the same user of the data center. In some implementations, client cluster A 202 and client cluster B 222 can be computing clusters for different users of the data center. The internal cluster can correspond to a computing cluster for the operators of the data center such as, for example, a management cluster that enables the operators of the data center to maintain and manage the data center. As depicted in FIG. 2, a singular telemetry services deployment in a first data center can service one or more client computing clusters, such as client cluster A 202 and client cluster B 222, and an internal cluster for the operators of the data center, such as internal cluster 242.

The telemetry services deployments in a first data center, such as the integrated telemetry services deployment 210, can forward the telemetry data from the computing clusters of the first data center, or connect, to one or more integrated telemetry services deployments in one or more data centers via a centralized telemetry subsystem. For example, the integrated telemetry services deployment 210 can connect to one or more integrated telemetry services deployment maintained in a second data center. The second data center can maintain one or more integrated telemetry services deployment and process, by the one or more integrated telemetry services deployments of the second data center, telemetry data generated by computing clusters in the second data center. The one or more integrated telemetry services deployments of the second data center can also provide the processed telemetry data to the centralized telemetry subsystem, such that the centralized telemetry subsystem can receive telemetry data from one or more computing clusters from one or more data centers. In such an example, in some cases, the user can receive telemetry data from one or more computing clusters in one or more data centers at the same user-defined endpoint.

The centralized telemetry subsystem can execute in any of one or more data centers. For example, the centralized telemetry subsystem can execute in the first data center, the second data center or in a data center different from the second data center.

In some implementations, the system 100 can maintain, by the data center, one or more connector subsystems that are configured to route data from the centralized telemetry subsystem to one or more external subsystems. That is, in some implementations, the client can configure, and the system can maintain, one or more connector subsystems with access credentials for accessing the external subsystem without exposure of the credentials to the centralized telemetry subsystem. For example, a first connector subsystem can be configured to route data to a virtual private cloud that is not addressable from inside the data center. In such a manner, the access credentials of the private external subsystem can remain classified while still enabling the telemetry data of the respective client clusters to be routed to the private external subsystem.

FIG. 3 shows an example of an integrated telemetry services deployment 210.

As described above, the integrated telemetry services deployment 210 can be servicing one or more computing clusters of the data center such as, for example, client cluster A 202, client cluster B 222 and an internal cluster 242.

At a high level, the integrated telemetry services deployment 210 can collect and process telemetry data for provisioning to one or more user endpoints 338 using a telemetry manager subsystem 390. More specifically, the integrated telemetry services deployment 210 can receive raw telemetry data from one or more computing clusters (and/or one or more other sources) and process the raw telemetry data, using one or more computing components, to generate one or more enriched telemetry data streams 385 for provisioning to (i) the operator of the data center for management and maintenance and as requested, (ii) a user of the data center. The user of the data center can, using a user interface 334, detail the desired data type 336 of telemetry data and one or more desired endpoints 338, and in response, a telemetry manager subsystem 390 can filter 393 the enriched telemetry data streams 385 to deliver the desired telemetry data to one or more desired user endpoints 338.

As the integrated telemetry services deployment 210 continuously collects and processes telemetry data, the telemetry data (in any of the below described forms) can correspond to a stream of telemetry data.

To transmit the raw telemetry data from the one or more client clusters, the one or more client clusters can each include one or more exporters. The one or more exporters can be configured to receive a stream of raw data from one or more computing components of the cluster (e.g., GPU, CPU, etc.) and process the stream of raw data such that it can be provided to the integrated telemetry deployment in a common language, or format, for the integrated telemetry services deployment to understand. The one or more exporters can perform any appropriate techniques, such as parsing, filtering, normalization, summarization, etc. For example, client cluster A 202 can include one or more exporters 307, client cluster B 222 can include one or more exporters 327 and the internal cluster 242 can include one or more exporters 347. In some implementations, the system 100 can include one or more other exporters 357 that transmit out-of-band raw telemetry data from one or more other computing resources.

One or more agents 360 can collect the raw telemetry data (but now in an ingestible format) from each of the one or more exporters and can transmit the collected telemetry data 365 to a cluster for processing. During collection of the raw telemetry data, the one or more agents 360 can filter the raw telemetry data into one or more particular streams of data. For example, every type of metric for every customer can be filtered into a different stream, such that auditable events of client A are in a first data stream, auditable events of client B are in a second data stream, network metrics for client A are in a third data stream, network metrics for client B are in a fourth data stream, etc. In some implementations, the one or more filters can be preconfigured. In some implementations, the one or more filters can be based on one or more attributes of the telemetry data, such as (i) the type of data, and (ii) the part of the computing stack from which the data is generated.

The one or more agents 360 can transmit the collected telemetry data 365 to a leaf cluster 370 for enrichment and routing. In particular, the leaf cluster 370 can be coupled to a data transformer 373 that enriches the collected telemetry data 365 by infusing extra context to the collected telemetry data to generate enriched telemetry data 375. That is, the data transformer 373 can consume the collected telemetry data 365 from the leaf cluster 370, enrich the collected telemetry data 365, and write the enriched telemetry data 375 to the leaf cluster 375 for forwarding and/or replicating. The data transformer 373 can enrich the telemetry data using any appropriate techniques, such as geographic enrichment, infrastructure mapping, tagging, etc. The data transformer 373 can be any appropriate type of data transformer configured to enrich the collected telemetry data 365. As a specific example, the data transformer 373 can be an echo data transformer.

Further, in some implementations, the data transformer 373 can ensure the enriched telemetry data 375 is routed to the appropriate client topic. That is, for each client to which one or more computing clusters are provisioned, the system 100 can create a new topic for the client in the cluster, such as the leaf cluster 370. In some implementations the daemon 333 manages the generation of new topics for new clients.

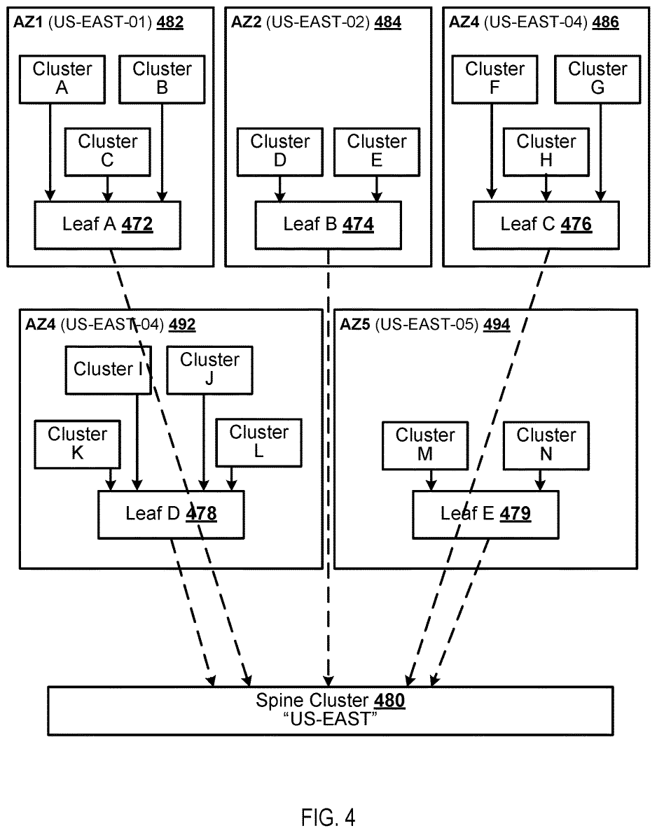

As described above, in some implementations, the integrated telemetry services deployment 210 can be a specialized Kubernetes cluster. The integrated telemetry services deployment 210 can include one or more leaf clusters and one or more spine clusters. The leaf cluster 370 can correspond to a data source such that messages of the integrated telemetry services deployment 210 (e.g., telemetry data) will be produced into a particular client topic (e.g., corresponding to the computing cluster from which the telemetry data was collected) from within the leaf cluster 370. That is, the particular client topic will be written to from a cluster producer that is also from within the particular leaf cluster 370, or in other words, from the same availability zone (AZ). The availability zone can correspond to a group of one or more data centers that act as a single unit within a geographic area, e.g., region. For example, the eastern region of the United States of America (also referred to as US-East) can include multiple availability zones, such as US-EAST-01, US-EAST-02, US-EAST-03, etc. Each leaf cluster can correspond to a particular availability zone (AZ) within a particular region. For example, leaf cluster 370 can correspond to the availability zone US-EAST-02 within the US-EAST region. Some or all client topics within the leaf cluster 370 can be mirrored into a spine cluster 380 within that region, (e.g., US-EAST, US-SOUTH, etc.). For example, a client topic produced to the leaf cluster 370 US-EAST-02 could be mirrored to the spine cluster 380 in US-EAST. That is, the spine cluster 380 can collect the enriched telemetry data from one or more leaf clusters from one or more availability zones within a particular region. The spine cluster 380 can correspond to a data destination where, as described above, messages will be mirrored from one or more leaf clusters from a particular region into the spine cluster in the same region. The relationship between leaves and spines are described in more detail below with reference to FIG. 4.

The telemetry deployment 330 can provide the enriched telemetry data streams 385 to one or more endpoints, including one or more internal endpoints corresponding to an operator of the data center for management and maintenance of the computing clusters. The telemetry deployment 330 can also, upon request, provide the enriched telemetry data streams 385 to one or more user-defined endpoints 338.

To request telemetry data, the system 100 can receive configuration information, such as information specifying (i) how to filter telemetry data by type and/or (ii) routing different types of telemetry data to different user endpoints 338. For example, the configuration information can indicate to the system 100 to send the enriched telemetry data streams 385 to a single user endpoint. As another example, the configuration information can define one or more filters 393 and indicate to the system 100 to send different filtered enriched telemetry data streams 385 to different user endpoints 338. The one or more filters 393 can be based on the one or more particular data streams that the telemetry data is filtered into during collection by the one or more agents 360. For example, the one or more filters can filter by client, such that only the telemetry data of the client is provided to the one or more user endpoints 338, and by type, such that only specific telemetry data streams are provided to the user endpoints 338. The one or more filters 393 can be specified in one or more formats, such as a list of values that a label must include in telemetry data provided to the user endpoints 338 and a list of values that a label must not include in telemetry data provided to the user endpoints 338. That is, the telemetry manager subsystem 390 can filter by only letting a message (e.g., a telemetry data stream) through if the label matches any value on the list of values. In some implementations, configuration information can be provided by the user through a user interface 334. In some implementations, the user interface 334 can be managed by the daemon 333. In some implementations, the configuration information can be provided programmatically, e.g., through one or more artificial intelligence (AI) models and/or one or more MCPs.

The telemetry manager subsystem 390 can receive the enriched telemetry data streams 385 from the telemetry deployment and using the one or more filters 393, filter the enriched telemetry data streams 385 to generate a subset of enriched telemetry data streams to be provided to the desired user endpoints 338. The one or more user endpoints 338 can be any appropriate user endpoints 338, such as HTTPS endpoints.

FIG. 4 illustrates the relationship between the leaf and spine clusters of an integrated telemetry services deployment, such as, e.g., the telemetry deployment 330 of FIG. 3.

As described above, in some implementations, the integrated telemetry services deployment can be a specialized Kubernetes cluster that includes one or more leaf clusters and one or more spine clusters.

As described above with reference to FIG. 3, a leaf cluster can represent a data source such that messages (e.g., telemetry data) from a computing cluster mapped to the leaf cluster can be produced into particular customer topics from within the leaf cluster. Each leaf cluster can correspond to one or more computing clusters as depicted in FIG. 4. For example, cluster A, cluster B and cluster C can map to leaf A 472, cluster D and cluster E can map to leaf B 474, cluster F, cluster G and cluster H can map to leaf C 476, and so on.

As described above with reference to FIG. 3, a spine cluster 380 can represent a data destination corresponding to a particular region, such that messages from one or more leaf clusters can be mirrored into a spine cluster in the same region. For example, as depicted in FIG. 4, the spine cluster 480 can be an example of the spine cluster 380 that corresponds to a particular region such as US-EAST and one or more leaf clusters, such as leaf A 472, leaf B 474, leaf C 476, leaf D 478 and leaf E 479, from one or more respective availability zones, such as, AZ1 (US-EAST-01), AZ2 (US-EAST-02), AZ3 (US-EAST-03), AZ4 (US-EAST-04) and AZ5 (US-EAST-05) can map to the spine cluster 480. The spine cluster 480 enables cluster consumers from an availability zone within the particular region to consume from any client topic within the spine cluster 480, and cluster producer from an availability zone within the particular region of the spine cluster 480 can produce into any client topic in the spine cluster 480 since it is local to the producer.

In some implementations, the leaf and spine topology can be horizontally scaled at each level. For example, the one or more clusters can be scaled such that a leaf node can correspond to one or more additional computing clusters within an availability zone. For example, the one or more leaf nodes can be scaled such that a spine cluster 480 can correspond to one or more additional leaf nodes, and thus one or more additional availability zones. As another example, the spine cluster 480 can be scaled such that the one or more leaf clusters map to additional spine clusters, instead of the one spine cluster 480.

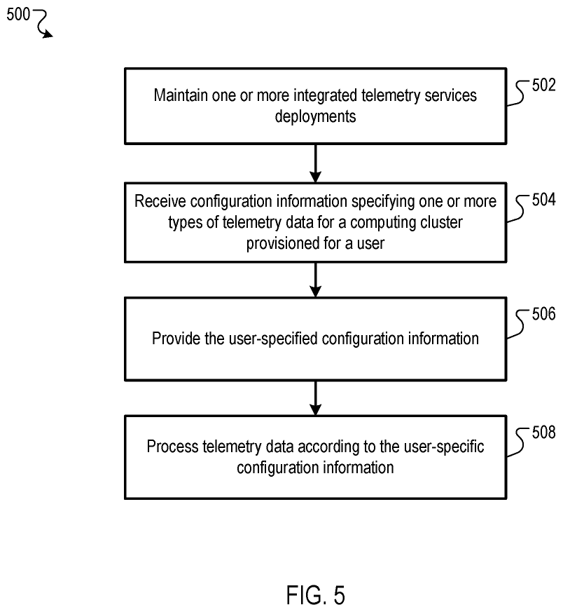

FIG. 5 is a flow diagram for an example process for processing user-specified telemetry data. For convenience, the process 500 will be described as being performed by a system of one or more computers located in one or more locations. For example, a system, e.g., the system 100 depicted in FIG. 1, appropriately programmed in accordance with this specification, can perform the process 500.

The system can maintain one or more integrated telemetry services deployments (502). As described in more detail with reference to FIGS. 1 and 2, the system can continuously maintain one or more integrated telemetry services deployments with each integrated telemetry services deployment servicing one or more computing clusters of a data center.

In some implementations, each of the integrated telemetry services deployments can be configured to service telemetry data from one or more different users. That is, in some cases, the one or more computing clusters can be provisioned for one or more different users of the data center, such that one integrated telemetry services deployment can service telemetry data of multiple users that are unaffiliated with one another. In such an example, the integrated telemetry services deployment is able to keep the user telemetry data separate and secure. In some implementations, the one or more different users can include both users and operators of the data center.

In some implementations, the one or more integrated telemetry services deployments can be executing before the configuration information is provided to the system 100. For example, in some implementations, the one or more integrated telemetry services deployments can be executing before the user provides configuration information requesting telemetry data. That is, the one or more integrated telemetry services deployments can continuously collect telemetry data from each of one or more computing clusters to provision to an operator of the data center for maintenance and management of the data center.

The system can receive, by a telemetry manager subsystem through a user interface for a user of the data center, configuration information specifying one or more types of telemetry data for a computing cluster of the data center provisioned for the user (504). As described in more detail above with reference to FIGS. 1, 2 and 3, a user can provide configuration information through a user interface of the data center to specify one or more types of telemetry data provisioned for the user. In some implementations, the configuration information can specify a quality of service parameter value for a particular type of telemetry data, and the centralized telemetry subsystem operates to effectuate the requested quality of service parameter value for the particular type of telemetry data. That is, in some implementations, the configuration information can specify a completeness and/or latency parameter that specifies a requested quality of service in terms of completeness (e.g., how much telemetry data is successfully provided to the user) and latency (e.g., how quickly the telemetry data is provided to the user after input of the configuration information). In some implementations, the configuration information can specify how to filter telemetry data by type, and can include one or more filters to include the telemetry data the user is interested in and to not include the other telemetry data. In some implementations, the configuration information can specify routing different types of telemetry data to different endpoints.

The system can provide, by the telemetry manager subsystem to one or more integrated telemetry services deployments, the user-specified configuration information (506). As described above in more detail with reference to FIGS. 1, 2, and 3, the system can provide the user-specified configuration information to the integrated telemetry services deployments to request the telemetry data.

The system can process, by the one or more integrated telemetry services deployments, telemetry data according to the user-specified configuration information (508). As described above with reference to FIG. 3, the integrated telemetry services deployments can process the telemetry data according to the user-specified configuration information by filtering the telemetry data to generate a subset of telemetry data corresponding to the type of telemetry data the user specified.

In some implementations, the system can provide, by the one or more integrated telemetry services deployments, the processed telemetry data to a centralized telemetry subsystem before sending out to user-endpoints. In such an example, the centralized telemetry subsystem can include telemetry data from one or more computing nodes of one or more computing clusters provisioned for the user. In some implementations, a second data center can maintain its own integrated telemetry services deployments and can process, by the one or more integrated telemetry services deployments of the second data center, telemetry data generated by computing clusters in the second data center and provide, by the one or more integrated telemetry services deployments of the second data center, the processed telemetry data to the centralized telemetry subsystem. In such a manner, the centralized telemetry subsystem can include telemetry data from one or more computing nodes from one or more computing clusters in one or more data centers, and provide that telemetry data to a user. In some implementations, the centralized telemetry subsystem can execute in a data center different from the second data center.

In some implementations, the system can process, by the centralized telemetry subsystem, the processed telemetry data to one or more user endpoints. That is, the centralized telemetry subsystem can include processed telemetry data from one or more computing nodes of one or more computing clusters provisioned to the user and can provide the processed telemetry data to the user.

In some implementations, the system can maintain, by the data center, one or more connector subsystems that are configured to route data from the centralized telemetry subsystem to one or more external subsystems. The one or more external subsystems can be any appropriate subsystems including a first connector subsystem configured to route data to a virtual private cloud that is not addressable from inside the data center.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A computer-implemented method comprising:
maintaining, in a data center comprising a plurality of computing nodes, a plurality of integrated telemetry services deployments;
receiving, by a telemetry manager subsystem for a user of the data center, configuration information specifying one or more types of telemetry data for a computing cluster of the data center provisioned for the user;
providing, by the telemetry manager subsystem to one or more integrated telemetry services deployments, the user-specified configuration information; and
processing, by the one or more integrated telemetry services deployments, telemetry data according to the user-specified configuration information.

2. The method of claim 1, wherein the plurality of integrated telemetry services deployments are executing before the configuration information is provided.

3. The method of claim 1, wherein each integrated telemetry services deployment is configured to service telemetry data from a plurality of different users.

4. The method of claim 3, wherein the plurality of different users served by a particular telemetry services deployment are unaffiliated with one another.

5. The method of claim 1, wherein the plurality of integrated telemetry services deployments service both users and operators of the data center.

6. The method of claim 1, further comprising:
providing, by the one or more integrated telemetry services deployments, the processed telemetry data to a centralized telemetry subsystem.

7. The method of claim 6, further comprising:
providing, by the centralized telemetry subsystem, the processed telemetry data to one or more user endpoints.

8. The method of claim 1, wherein a second data center maintains its own integrated telemetry services deployments, and further comprising:
processing, by the one or more integrated telemetry services deployments of the second data center, telemetry data generated by computing clusters in the second data center; and
providing, by the one or more integrated telemetry services deployments of the second data center, the processed telemetry data to the centralized telemetry subsystem.

9. The method of claim 8, wherein the centralized telemetry subsystem executes in a data center different than the second data center.

10. The method of claim 1, further comprising:
maintaining, by the data center, one or more connector subsystems that are configured to route data from the centralized telemetry subsystem to one or more external subsystems.

11. The method of claim 10, wherein a first connector subsystem is configured to route data to a virtual private cloud that is not addressable from inside the data center.

12. The method of claim 1, wherein the configuration information specifies a quality of service parameter value for a particular type of telemetry data, and wherein the centralized telemetry subsystem operates to effectuate the requested quality of service parameter value for the particular type of telemetry data.

13. The method of claim 1, wherein the configuration information specifies how to filter telemetry data by type.

14. The method of claim 1, wherein the configuration information specifies routing different types of telemetry data to different endpoints.

15. The method of claim 1, wherein the configuration information is received through a user interface.

16. The method of claim 1, wherein the configuration information is received from an additional computing component.

17. A system comprising:
one or more computers and one or more storage devices storing instructions that are operable, when executed by the one or more computers, to cause the one or more computers to perform operations comprising:
maintaining, in a data center comprising a plurality of computing nodes, a plurality of integrated telemetry services deployments;
receiving, by a telemetry manager subsystem through a user interface for a user of the data center, configuration information specifying one or more types of telemetry data for a computing cluster of the data center provisioned for the user;
providing, by the telemetry manager subsystem to one or more integrated telemetry services deployments, the user-specified configuration information; and
processing, by the one or more integrated telemetry services deployments, telemetry data according to the user-specified configuration information.

18. The system of claim 17, wherein the plurality of integrated telemetry services deployments are executing before the user provides the configuration information.

19. The system of claim 17, wherein each integrated telemetry services deployment is configured to service telemetry data from a plurality of different users.

20. One or more non-transitory computer-readable storage media encoded with a computer program instructions that are operable, when executed by data processing apparatus, to cause the data processing apparatus to perform operations comprising:
maintaining, in a data center comprising a plurality of computing nodes, a plurality of integrated telemetry services deployments;
receiving, by a telemetry manager subsystem through a user interface for a user of the data center, configuration information specifying one or more types of telemetry data for a computing cluster of the data center provisioned for the user;
providing, by the telemetry manager subsystem to one or more integrated telemetry services deployments, the user-specified configuration information; and
processing, by the one or more integrated telemetry services deployments, telemetry data according to the user-specified configuration information.
